(19) United States
(12) Patent Application Publication
(10) Pub. No.: US 2013/0132164 A1
(43) Pub. Date: May 23, 2013

(54) Assessment Exercise Second Review Process

(71) Applicant: David Michael Morris, Alexandria, VA (US)

(72) Inventor: David Michael Morris, Alexandria, VA (US)

(21) Appl. No.: 13/674,600

(22) Filed: Nov. 12, 2012

Related U.S. Application Data
(60) Provisional application No. 61/562,961, filed on Nov. 22, 2011.

(51) Int. Cl. G06Q 10/00

(52) U.S. Cl. CPC G06Q 10/00
USPC 705/7.38

(57) ABSTRACT

A second review process comprises: recording a performance of a candidate in assessment exercises in an examination of the candidate and producing a candidate performance record; providing the candidate with a performance rating in the exercises and an opportunity to view the candidate performance record; providing the candidate with an option to request a second review of the performance in at least one of the assessment exercises; accepting a request from the candidate for a second review of the performance; convening a panel of assessors to perform the second review of the performance; performing the second review of the performance to produce a second review decision, wherein the second review decision addresses the performance rating; recording the second review decision by the panel of assessors; and providing a record of the second review decision to the candidate and to an administrator.

### REFERENCE TO RELATED APPLICATION

This application claims priority to U.S. Provisional Patent Application No. 61/562,961, filed Nov. 22, 2011, entitled “Assessment Exercise Second Review Process.”

### BACKGROUND OF THE INVENTION

The present invention relates to a standardized procedure for allowing candidates for any high stakes promotional or selection assessment procedures, such as those used for protective services, education or in certain occupations in the private sector, for whom performance based testing may be required to seek redress from possible or perceived error and to appeal their scores.

### SUMMARY OF THE INVENTION

In one aspect of the present invention, a second review process comprises the steps of: recording a performance of a candidate in assessment exercises in an examination of the candidate and producing a candidate performance record; providing the candidate with a performance rating in the exercises and an opportunity to view the candidate performance record; providing the candidate with an option to request a second review of the performance in at least one of the assessment exercises; accepting a request from the candidate for a second review of the performance; convening a panel of assessors to perform the second review of the performance; performing the second review of the performance to produce a second review decision, wherein the second review decision addresses the performance rating; recording the second review decision by the panel of assessors; and providing a record of the second review decision to the candidate and to an administrator.

In another aspect, the process further comprises receiving from the candidate an acknowledgement that the second review decision may increase or decrease the performance rating. In another aspect, the process further comprises requiring that the candidate view the candidate performance record before the step of performing the second review of the performance. In another aspect, the process further comprises receiving evidence that the candidate viewed the candidate performance record before the step of performing the second review of the performance. In another aspect, the process further comprises providing calibration training for the panel of assessors. In another aspect, the step of performing the second review of the performance to produce a second review decision comprises applying a reasonable person standard in addressing the performance rating.

These and other features, aspects and advantages of the present invention will become better understood with reference to the following drawings, description and claims.

### BRIEF DESCRIPTION OF THE DRAWINGS

FIG. 1 shows a flow chart according to one embodiment of the present invention.

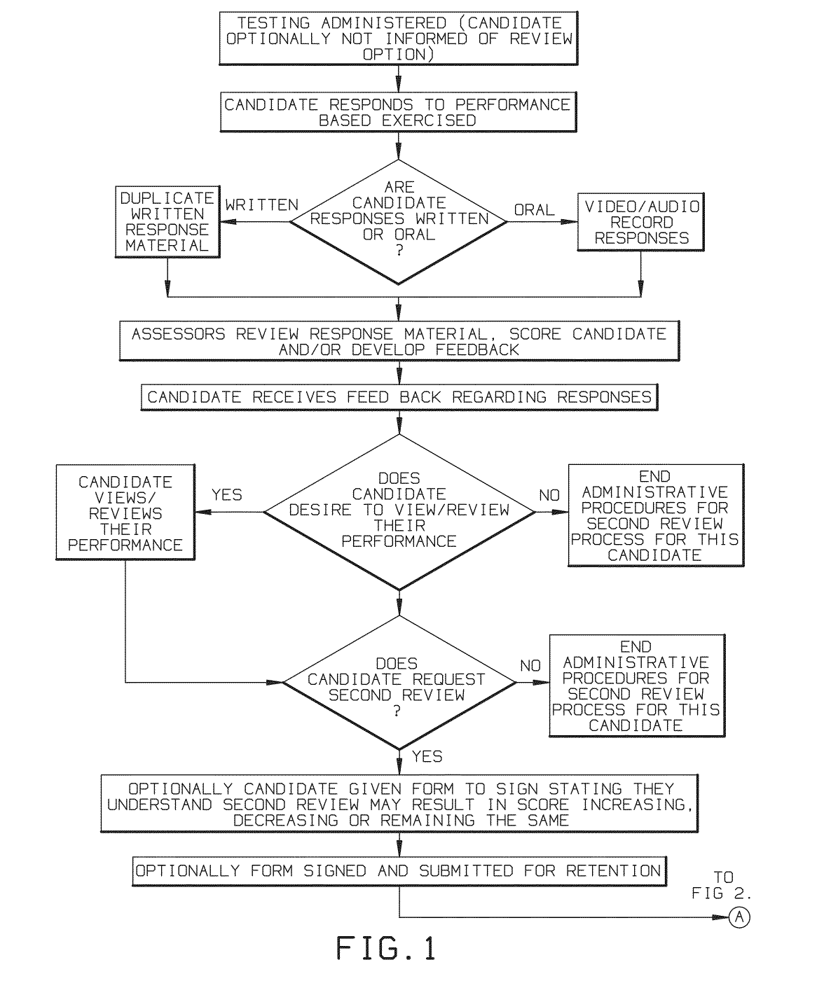

FIG. 2 shows a continuation of the flow chart shown in FIG. 1.

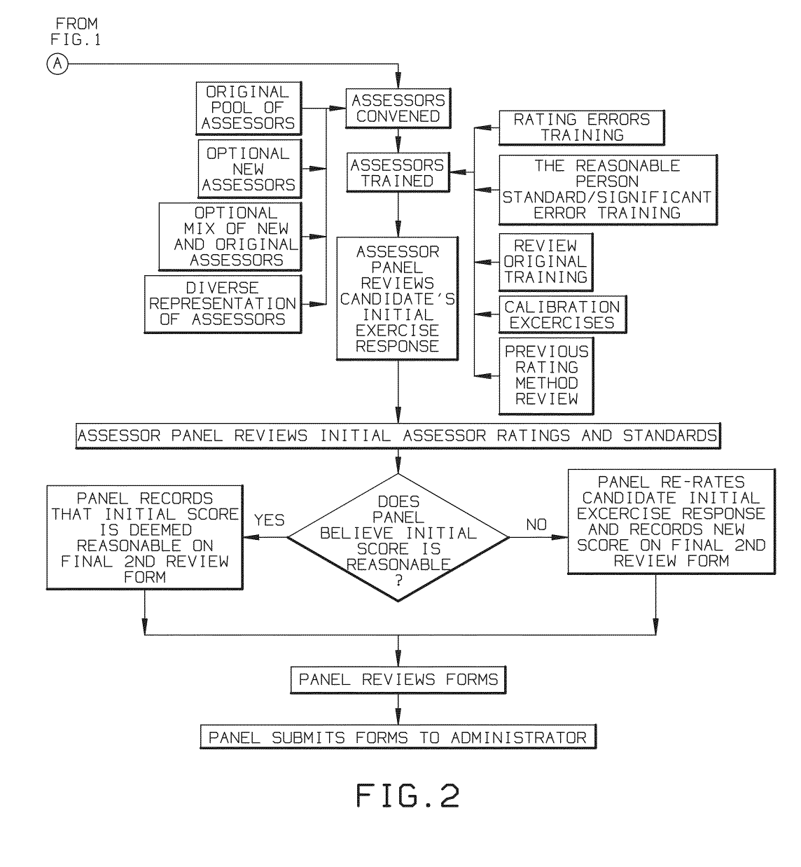

FIG. 3 shows a flow chart showing steps in a performance review appeal process according to an embodiment of the invention.

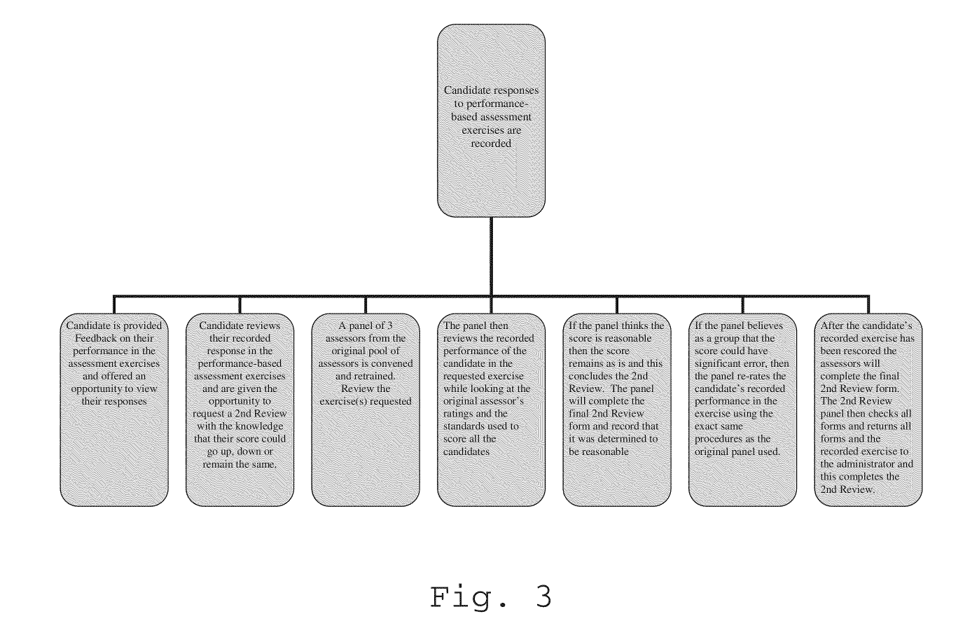

FIG. 4 shows a form by which a candidate requests a second review of his performance.

FIG. 5 shows a form by which the results of a second review are reported.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, an embodiment of the present invention generally provides a standardized procedure for allowing candidates for any high stakes promotional or selection assessment procedures, such as those used for protective services, education or in certain occupations in the private sector, for whom performance based testing may be required to seek redress from possible or perceived error and to appeal their scores. The invention also comprises standardized forms for use by the candidate in requesting a second review and for use by evaluators to report the results of the second review to the candidate.

According to an exemplary embodiment of the invention, there is provided a standardized procedure that may be followed by evaluators in consideration of a request for a second review by a candidate.

Initially, a candidate may respond to a performance-based assessment and his responses may be recorded. A record of the assessment may be necessary before any possible review. A candidate's performance could be video-recorded, audio-recorded or reported by human observers. If the exercise may be written, the candidate's written response would serve as a record of the candidate's performance. The candidate may be informed that a second review may be available on request.

The candidates may then receive oral or written feedback on their performance made by assessors trained to use behavioral based assessments, and the candidates are offered an opportunity to view their recorded exercise performance before they are shown a rank-ordered list.

A candidate may then choose to review his recorded exercise before he may be given an opportunity to request a second review. This step can assure that the candidate may be fully informed on his own performance before making the request.

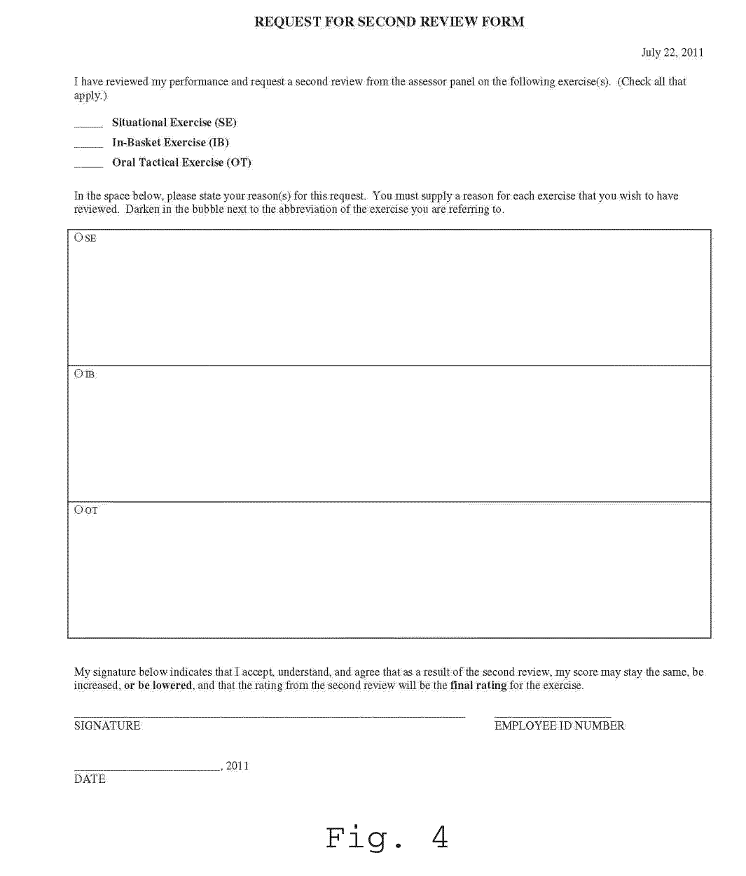

If, after viewing the recorded exercise, the candidate believes there is significant error in the exercise score, he may request a second review using, for example, the request form shown in FIG. 4, acknowledging in writing that his score could go up, down, or remain the same. The written request documents that the candidate understands the request may be based on his belief that there is significant error, and understands the possible outcomes of his request.

If a candidate requests a second review, a panel of, for example, three assessors for the second review is convened and trained, including training on a reasonable person standard and calibration training. For calibration training, the panel can review the performance of an adequate number of candidates who participated in the original assessment but who did not request a second review, and those who score at various levels, including low-scoring, mid-range scoring and high scoring candidates in the same exercise. The purpose of calibration can be to assure that the panel can be aware of the scoring used by the original panel before determining whether there is an error in the score of the individual who may be requesting a second review.

The panel of assessors may then review the original recorded performance of the candidate in the exercise, while looking at the original assessor's ratings and the standards used to score all the candidates.

If the panel believes the original score is reasonable, then the score may stand and the second review is concluded. The re-rating may not be conducted unless it may be first decided that the score for the candidate fails the reasonable person standard. If the panel believes the original score is in error, they may then re-rate the candidate using the same steps and procedures as in the original assessment.

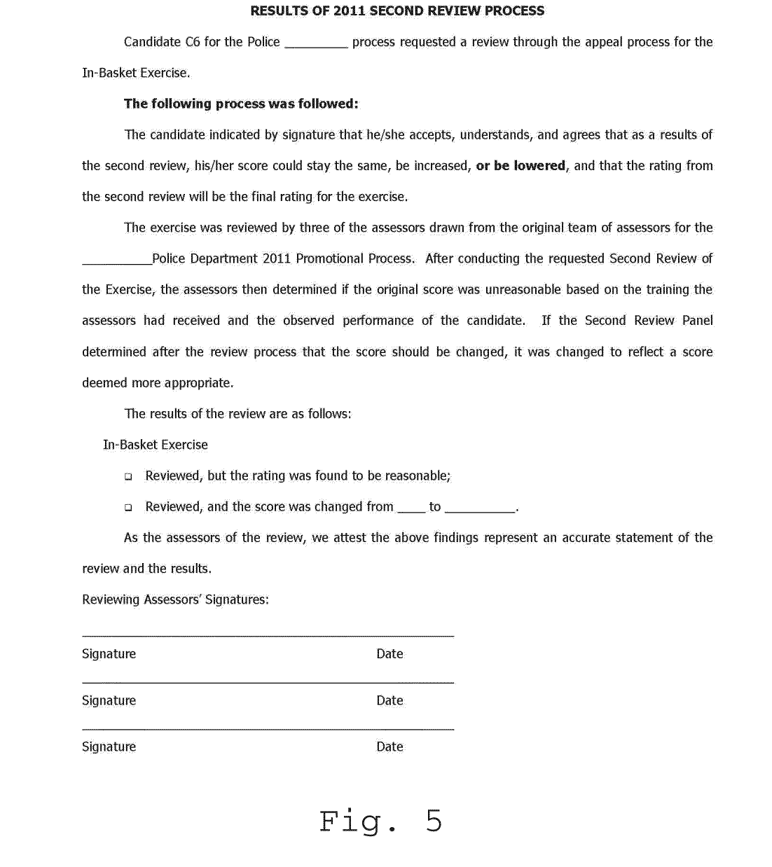

After the candidate's recorded exercise may be rescored, the panel can then complete the final second review form, such as the example shown in FIG. 5 and record that it was determined to be reasonable, or indicate what changes occurred from the re-rating. All forms and the recorded exercise are returned to an administrator.

The process described can be used optionally in any high stakes promotional or selection assessment procedures, such as those used for protective services, education or in certain occupations in the private sector.

Existing appeal options for high stakes performance based entry level or promotional testing either do not exist or are very limited. The described process can allow a candidate to appeal, limiting liability to those candidates who may choose to appeal and provide a fair and structured procedure to handle such appeals that protects employers from lawsuits as well. The process can thus save protective services, such as fire and police departments, significant expense and resources and can provide a higher level of fairness to the candidates.

Another embodiment of the present invention, method, and/or software is described below in a series of steps.

Step 1: The candidate should be told in advance that the review is possible and they can request it. (This is not an essential step and can be made after the evaluation.)

The candidate could be told after the evaluation and informed that this is an administrative relief that is being offered to him or her after the fact. It is also possible that a reviewing body of assessors, or other decision makers, instead of the candidate could perform this step.

Step 2: The organization should make a record of the candidate's response in the high stakes employment test. If the candidate's response is a written one, then a duplicate of his/her written response will be made. If the candidate's response is an oral response, then his/her oral response must be video recorded. If the evaluation of the candidate's response was made exclusively or primarily on the basis of the words the candidate spoke, then an audio recording will be sufficient. If any part of the evaluation depended on non-verbal responses, then the candidate's response should be video recorded and video should be considered because the visual cues makes the raters' and the reviewers' task more engaging.

It is conceivable that the candidate's response if not recorded in some manner could be recaptured from the memories of the assessors that participated or from their notes of observing the candidate. These notes could serve as an imperfect recording of the assessor's performance, but the notes or the memories of one or more of the assessors could be used to complete this step of the 2^{nd} Review. It is also possible that a reviewing body of assessors, or other decision makers, instead of the candidate could perform this step.

Step 3: After the Candidate has received feedback formal or otherwise, on how well they did in the performance based assessment exercise, they should view and review their recorded performance in the test exercise (written, audio recorded, or video recorded) before they can request a second review. This may be a requirement to have standing (legal or otherwise) to request a second review and/or appeal.

This step could be eliminated or modified so that the candidates after receiving their score, could request a 2^{nd} Review without reviewing their recorded performance or without reviewing their performance as documented by the assessors notes, or by reviewing their performance in a meeting with one or more of the assessors. In addition this step could be modified to where the candidate after receiving their score, they could request or be offered a review of the notes of the assessors, or could request or be offered to meet with the assessors who would provide the candidate with a review of their performance in the exercise. It is also possible that a reviewing body of assessors, or other decision makers, instead of the candidate could perform this step.

Step 4: Based on the candidate's review of his or her recorded performance and the score and feedback, he or she was provided before viewing and reviewing their recorded performance, if the candidate believes there is significant error in their score on the exercise he or she may request a second review.

If the review is conducted as described by the alternative methods as described in the previous step 3 variations, then the candidate could request the 2^{nd} Review based on these modifications. It is also possible that a reviewing body of assessors, or other decision makers, could have the role of making the request for the 2^{nd} Review.

Step 5: Although not essential, the candidate should be required to sign a form which states that he or she understands that the Second Review may result in his or her score 1) remaining the same 2) increasing in value or going up, 3) or decreasing in value by going down.

This step could be eliminated, however there may not be the assurance that the candidate was fully aware of the consequences of his request, that is his or her score could go down. It is also possible that a reviewing body of assessors, or other decision makers, instead of the candidate could perform this step.

Step 6: After the candidate has made the request for a Second Review or in some cases a reviewing body or panel may make the request, a panel of assessors (such as three assessors) is convened, usually drawn from the original pool of trained assessors and there may be one or two assessors who rated the candidate originally but there is an attempt to have at least one assessor who did not sit on the original rating panel conduct the Second Review Process. There is a goal of having diverse representation of Assessors on the Second Review Panel which to the extent practical represents the ethnic, race, or other protected category of persons to which the candidate belongs. For instance, if the candidate is an African American we would attempt to have that protected group represented on the panel.

The panel convened could be 1 or 2 or 3 or more persons to serve this purpose. The persons may not have served in the original pool of assessors. The 2^{nd} review could be conducted with persons who did not rate the candidate originally. It is also possible that a reviewing body of assessors, or other decision makers, instead of the candidate could perform this step. It is possible that the panel or person could be picked without regard to the diversity of the candidate pool. It is possible that the diversity of the candidate pool is not taken into account and that diversity is sought regardless of the makeup of the candidate pool.

Step 7: Once the Second Review Panel of Assessors is convened they are trained in the following manner.

The original training program that was provided to the assessors before they made their ratings on the exercises is reviewed by the trainer pointing out, emphasizing the rating behaviors susceptible to human error.

The Second Review Panel(s) of rating assessors are then instructed that their goal is to treat the candidate's request as a request emanating from a sincere and genuine feeling that the candidate believes that there is clear and significant error in his or her score of his or her performance on the particular exercise for which the request was made. Further the assessors that may have participated in the original rating of this candidate's performance are encouraged to take the position that their goal should not be to prove they were right the first time, but to be thankful that if there is error, as is possible with all things human, this is their chance to “get it right”.

Then the assessors participate in a calibration exercise in which they review two (2) to three (3) performances by low scoring candidates in the exercise, two (2) to three (3) candidates who score in the middle of the range of scores, and two (2) to three (3) candidates who scored high in the range of scores on the particular exercise. All candidates recordings used for this calibration exercise should not contain any candidates who requested the Second Review.

The second review panel is then reminded that before they review the candidate's record including the first assessor ratings on the dimensions and the recording of the candidate's performance, that the final rating the candidate received in the first instance was an integration and or a consensus of multiple assessors on a panel. It would not be the norm for all assessors on that panel to give the candidate the exact same score on each of the dimensions or the same score on the exercise overall. For this reason, as each of the assessors on the 2^{nd} review panel review the candidates original rating record and candidates performance in the exercise they should not ask themselves if the score the candidate received was the exact same score they would have given the candidate but rather is this a score that could have been reasonably expected from a panel trained as they were trained and using the same scoring procedures. The question should not be is the score the candidate received the SAME they would have given them, but is it a reasonable overall score (based on a reasonable person standard) for a panel trained as they were trained and using the same procedures they were trained to use.

A person rather than a panel might serve this function. The training could be varied so that the panel or person is trained using the same training program as before, instead of giving a summary of the training. The training may not emphasize all ratings are susceptible to error.

The training program could vary but contain training on the exercises and the standards and the same dimensions on which the candidate was originally evaluated and scored. Any variation on the reasonable person standard could be used for the training. The reasonable person standard may not be used in the training.

Step 8: The panel then reviews the recorded performance of the candidate in the exercise while looking at the original assessor's ratings and the standards used to score all the candidates.

It is possible that the panel or person serving in this capacity does not review the original ratings made in the first evaluation. It is possible although not advisable that the panel or person does the 2^{nd} review “de novo.” The reviewing panel or person should review the record of the first reviewers as a starting point.

Step 9: If the panel thinks the score is reasonable then the score remains as is and this concludes the 2^{nd} Review. The panel will complete the final 2^{nd} Review form and record that it was determined to be reasonable.

It is possible that the panel or person serving in this capacity could make the decision without a form, and either orally report the finding or use a letter that is uniquely written to report the findings.

Step 10: If the panel believes as a group that the score could have significant error, and that it is either too low, or too high of a rating then the panel re-rates the candidate's recorded performance in the exercise using the exact same procedures as the original panel used.

A person rather than a panel could conduct this step. The panel or person could re-rate the candidate without making the initial decision that significant error exists or does not exist. The person or panels could use different procedures than those used by the original rating assessors.

Step 11: After the candidate's recorded exercise has been rescored the assessors will complete the final 2^{nd} Review form.

This step could be handled without a form, and either orally report the finding or use a letter that is uniquely written to report the findings.

Step 12: The 2^{nd} Review panel then checks all forms and returns all forms and the recorded exercise to the administrator and this completes the 2^{nd} Review.

It is possible that a person could perform this administrative task rather than the person making the actual decision.

Values in each of these steps are described below.

Step 1: All measurement has error in it. Performance based assessments, e.g. assessment center or structured oral board, when conducted for high stakes employment events such as entry level decisions or promotional decisions are subject to civil rights laws or civil service laws and as such can be highly litigious events. Allowing candidates who believe they have been scored wrongly to request a 2^{nd} Review serves three purposes 1) it allows the employer to check to see if there is significant error before it goes to a legal arbiter such as a judge, jury , or arbitrator, and if so to correct it; and 2) by providing this administrative relief to the candidates , in most cases the candidate will be required to exhaust this administrative remedy before they seek legal relief; 3) it helps restrict the pool of possible aggrieved candidates that would have standing in future litigation for the reasons that the aggrieved candidates are addressing (error in their score).

Informing the candidates of this possible administrative relief for them ahead of time has the benefit of candidate fairness, and transparency on the process. In the past candidates for most performance based assessments had little redress if he or she believed there was significant error. Knowing this ahead of time and before the assessment lets them know going into it that they do have this possible relief available to them and reduces the possible hostility of candidates to the notion of being assessed. It gives the candidate both a role in getting their score right and the responsibility for using the relief.

Step 2: Recording the candidate's performance has many benefits. Without the recording it is simply the candidate's word against the evaluator or assessors. Recent court decisions (e.g., Akron firefighters) have turned on the fact that without a recording there is no way for the arbiter, whether it is a judge, jury, or arbitrator to know whether the candidate's performance in the exercise was rated reasonably or not. If there is no recording a 2^{nd} Review can still be conducted, but it has room for more error, since it will depend on the notes, or memory of the evaluator or the assessors.

Step 3: If the candidate's performance was recorded, requiring the candidate to view his or her recorded performance often enhances the candidates understanding of the evaluator's or assessor's point of view. When this step is required, it is estimated that approximately 20% or less of all candidates taking the exercise will proceed in the procedure to request a 2^{nd} Review. This has the legal advantage in many cases of reducing the pool candidates that have standing to challenge the process on the grounds of the kind of error that the 2^{nd} Review process addresses by 80% of the candidate population. This represents a huge advantage for most large public jurisdictions or large private employers. The assessors might require evidence from the candidate that the performance record was actually reviewed, such as by quizzing the candidate on features or elements in it, receiving a written or signed statement to that fact, asking for corroborating testimony from a witness, or any other evidence that could show that the record was reviewed by the candidate.

Step 4: This gives the candidate a chance to participate in the process, and also gives him the responsibility. Those candidates that do come actually come in to review their recorded exercise are estimated to be less than half and 20% or less will eventually request the 2^{nd} Review. Giving the candidate this responsibility and opportunity is seen by most organized employee groups as an enhanced degree of transparency and fairness. Requiring the candidate to take the affirmative administrative step tends to eliminate the less than seriously disgruntled candidates and allows those that may believe that they have been scored unfairly or in error a higher degree of administrative relief than was provided in the past.

Step 5: Requiring the candidate to make this request in writing using a form and informing them of the possible outcomes standardizes the process and documents that they knew the possible outcomes included their score going down. This step reduces misunderstandings or allegations of misunderstandings.

Step 6: Using assessors drawn from the original pool reduces training time. Since these individuals have already been through a formal training program targeted to the candidate population it means that a refresher course on performance based training, e.g., assessment center or structured oral board may be provided instead of the one day or more that might be required otherwise. This is a savings for jurisdictions or the employers. It also reduces considerably the time that the assessors will be required for the task. Striving for a diverse panel in the assessors may help mitigate concern that minority candidates might have and it improves the employer's posture in court in the event of a Title VII challenge. The value of preferring to have at least one assessor from the original panel is that assessor can inform the other panel members the rationale behind the original rating without feeling they must defend it. The value of having at least one new assessor on the panel is to garner a fresh look, while balancing the interest of presenting the rationale for the first rating. This step can be done with all new assessors drawn from the original pool which will still save training time, or this step could be conducted with all new assessors, but the increased time for training will have to be dealt with.

Step 8: It is possible that the panel or person serving in this capacity does not review the original ratings made in the first evaluation. It is possible that the panel or person does the 2^{nd} review “de novo.”

Step 9: It is possible that the panel or person serving in this capacity could make the decision without a form, and either orally report the finding or use a letter that is uniquely written to report the findings.

Step 10: A person rather than a panel could conduct this step. The panel or person could re-rate the candidate without making the initial decision that significant error exists or does not exists. The person or panels could use different procedures than those used by the original rating assessors.

Step 11: This step could be handled without a form, and either orally report the finding or use a letter that is uniquely written to report the findings.

Step 12: It is possible that a person could perform this administrative task rather than the person making the actual decision.

Use of the invention is described further as follows. Even though Performance-Based Assessments are reliable and consistent, as with all measures and assessments, there is possible error. The second review acknowledges this fact. Its purpose is to detect and address significant error. The second review gives the candidate a role in this process by allowing the candidate to review his/her own video-taped performance and score. If the candidate believes the score is reasonable, then the process stops there. If the candidate believes there is significant error for one or any of the exercises, the candidate signs a form requesting a second review be made by the panel of assessors.

Step 1: The candidates are told in writing, as part of the candidate orientation for the assessment process.

Step 2: The candidate's performance could be video-recorded, audio-recorded, reported by observers (although subject to human error) or if it is a written exercise—the candidate's written response would serve as record of the candidate's performance.

Step 3: The candidate may receive written feedback, and oral feedback, although not as desirable. After the Candidates have received feedback formal or otherwise, on how well they did in the performance based assessment exercise, e.g. assessment center, or structured oral board, they must view and review their recorded performance in the test exercise (written, audio recorded, or video recorded).

Step 4: The Candidate completes a written request. It is best to prepare a form for this.

Step 5: The 2nd Review Panel can be recruited from the original panel although it is best to have one assessor who did not review it the first time for new input. Once the 2nd Review Panel is convened, they are trained on the original training program, the reasonable person standard, and the calibration training. The 2nd Review Panel is instructed to treat the candidate's request as a request emanating from a sincere and genuine belief that there is error in the original rating.

Step 6: The panel then reviews the recorded performance of the candidate in the exercise while looking at the original assessors' ratings and the standards used to score all the candidates.

Step 7: If the panel thinks the score is reasonable then the score remains as is and this concludes the 2nd Review. If the panel believes there is error then they rerate the candidate using the same steps and procedures as used in the original assessment. The panel will complete the final 2nd Review form and record that it was determined to be reasonable, or what changes occurred from the rerating.

The second review process/method/software may also include steps that may be performed by or aided with a computer, and may include any of the following steps.

Step 3a: The candidate will receive an e-mail notifying him/her that their exercises have been scored and his /her feedback on the exercises is available and can be viewed using a secured server. The candidate can then log onto a secured server with the security token provided in the email and review their scores and feedback.

Step 3b: After the candidate has reviewed the score, an informational sheet will be provided on the screen describing their option to come in to a monitored site and view their recorded performance in the exercises and that following the candidate's viewing their recorded performance they will be presented with information on an option to request a second review of their performance by the assessors. The candidate indicates their intention to review their recorded performance. The candidate will then be notified electronically of appointment with jurisdiction administrator to review first video recording.

Step 3c: The candidate reports to a monitored site and requests to view their recorded performance. The candidate meets with administrator. Administrator logs into secure server to show the candidate his/her video recording in all of the exercises.

Step 4: After reviewing the performance in the exercises, the candidate will have a screen that presents a description of the second review on an informational sheet. After candidate reviews description of the 2^{nd} review, the screen will ask them if they would like to select the option of a second review. If candidate wants to proceed they will be instructed to sign release form stating their score could drop, improve, or remain the same.

Step 5: If they chose to request second review, they will fill out a web-form and submit. A second submit will be requested to assure no misunderstandings about their intentions. Upon submitting the web-form, the jurisdiction administrator will be electronically notified of the candidate's request.

Step 6: The new assessor panel is formed, either by an administrator or stratified randomized selection by computer.

Step 7: The new assessor panel logs in to secure server for assessor training for the second review.

Step 8-11: The new assessor panel logs in to secure server and queries a SQL database for candidate profile and electronic link to candidate video. After review and collaboration the assessor panel will use an electronic form to submit the final second review form which will be saved in the candidate profile within the SQL database located on the secure server.

SQL or “sequel”; or Structured Query Language) is a special-purpose programming language designed for managing data in relational database management systems (RDBMS).The most common operation in SQL is the query, which is performed with the declarative SELECT statement. SELECT retrieves data from one or more tables, or expressions. Queries allow the user to describe desired data, leaving the database management system (DBMS) responsible for planning, optimizing, and performing the physical operations necessary to produce that result as it chooses. Basically it's a database language. You can put large amounts of data into tables within a database and query specific information from within one or multiple tables.

Step 12: The new assessor panel will then review and confirm all second review forms on computer, through secure server. Upon completion of the second review, all review data and scoring information will be submitted and saved to the secure server. This will automatically update Candidate's score report.

Step 13: After the completion of all candidate testing and reviews including appeals (Second Reviews), all jurisdiction candidate test and review data is removed from secure server and delivered to jurisdiction administrator either in the form of DVDs or electronic file transfer.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A second review process, comprising the steps of:
recording a performance of a candidate in assessment exercises in an examination of the candidate and producing a candidate performance record;
providing the candidate with a performance rating in the exercises and an opportunity to view the candidate performance record;
providing the candidate with an option to request a second review of the performance in at least one of the assessment exercises;
accepting a request from the candidate for a second review of the performance;
convening a panel of assessors to perform the second review of the performance;
performing the second review of the performance to produce a second review decision, wherein the second review decision addresses the performance rating;
recording the second review decision by the panel of assessors; and
providing a record of the second review decision to the candidate and to an administrator.

2. The second review process as claimed in claim 1, further comprising receiving from the candidate an acknowledgement that the second review decision may increase or decrease the performance rating.

3. The second review process as claimed in claim 1, further comprising requiring that the candidate view the candidate performance record before the step of performing the second review of the performance.

4. The second review process as claimed in claim 3, further comprising receiving evidence that the candidate viewed the candidate performance record before the step of performing the second review of the performance.

5. The second review process as claimed in claim 1, further comprising providing calibration training for the panel of assessors.

6. The second review process as claimed in claim 1, wherein the step of performing the second review of the performance to produce a second review decision comprises applying a reasonable person standard in addressing the performance rating.
